(19) United States
(12) Patent Application Publication
(10) Pub. No.: US 2006/0218797 A1
(43) Pub. Date: Oct. 5, 2006

(54) Continuous feed string trimmer

(76) Inventor: James D. Mitchell JR., (US)

Correspondence Address: James D. Mitchell, Jr., 3800 Coopers Mountain Road, Martinsville, VA, 24112, US

(21) Appl. No.: 11/394,445

(22) Filed: Mar. 31, 2006

Related U.S. Application Data
(60) Provisional application No. 60/668,195, filed on Apr. 4, 2005.

(51) Int. Cl. B26B 7/00

(52) U.S. Cl. 30/276

(57) ABSTRACT

A continuous feed line trimmer in which the spool or container of reserve cutting line is mounted independently from the trimmer. The trimmer having a set of gears or rollers that pull the cutting line from the spool or container forcing it through a hollow tube then through a hollow rotating shaft and then through a rotating cutter head to cut vegetation. By mounting the reserve spool or container of cutting line independently of the trimmer the footage of cutting line held in reserve is increased dramatically, thereby enormously reducing the downtime used to replenish cutting line. Trimmer can be mounted as a stand alone unit with its own power source or can be mounted as an auxiliary attachment on mowers, tractors etc.

### CROSS REFERENCE TO RELATED APPLICATION

This application claims priority from U.S. provisional application Ser. No. 60/668,195 filled Apr. 4, 2005.

### BACKGROUND OF THE INVENTION

This invention relates to a continuous method of feeding flexible cord to a powered trimmer for the cutting of grass or other vegetation.

### DESCRIPTION OF THE RELATED ART

Lawnmowers of the present day are unable to mow all the grass or vegetation that grows next to trees, fences, buildings, tombstones etc. For years the use of a trimming device with a flexible cutting line of different materials has been used to trim these hard to reach areas.

The purpose for using flexible cutting line on a trimming device is to remove the unwanted vegetation or grass without damaging the object that the vegetation or grass surrounds.

The disadvantage of using the flexible cutting line is that it becomes damaged or will wear away and has to be replaced often. There are different methods used to replace the cutting line. One method is patent U.S. Pat. No. 4,685,279 in which a precut length of cutting line is inserted into the trimmer head.

Another method is patent U.S. Pat. No. 4,285,128 in which a spool feeds cutting line down to the head of the trimmer through a handle. The spool is released by a mechanical trigger to feed the cutting line.

Another method is patent U.S. Pat. No. 5,657,542 in which the trimmer head is bumped on the ground to advance the cutting line.

Another method is patent U.S. Pat. No. 6,862,811 B2 in which the feeding mechanism is activated by bumping the top of the trimmer head with a handle or other means to feed the cutting line.

All of these methods are limited by the amount of flexible cutting line that can be held in reserve to replenish the cutting line protruding from the trimmer head, which comes into contact with the vegetation or grass to be cut, without ceasing rotation of the cutter head. In most cases the flexible cutting line used to replenish cutting line is stored within the trimmer head and rotates with the head or is stored in the trimmer itself. The footage units of flexible cutting line that can be held in reserve, usually is in the single digit or lower double digit range. This has a very limiting effect on the amount of flexible cutting line that can be held in reserve, therefore causing the operator to have to stop often to replenish the reserve line.

### SUMMERY OF THE INVENTION

A continuous feed string trimmer for lawn maintenance is described.

With this continuous feed string trimmer the spool or container holding the flexible cutting line reserve is mounted independent from the trimmer and is not limited in the footage units of the flexible cutting line that can be held in reserve to replenish the cutting line protruding from the head that comes into contact with the vegetation or grass to be cut without ceasing the rotation of the cutter head. The footage units of flexible cutting line held in reserve can range from single digit units, double digit units, 3 digit units, 4 digit units, etc. because the reserve spool or container holding the cutting line is mounted independently.

The flexible cutting line from the reserve spool or container travels between two rollers or gears at the point that the rollers or gears come into contact with each other. One gear or roller is driven and the other gear or roller is an idler. The idler gear or roller is mounted so that the tension or pressure against the driven gear or roller can be adjusted. The driven gear or roller can be powered hydraulically, electrically or mechanically. The driven gear or roller can turn clockwise or counter clockwise. When additional cutting line is needed the driven gear or roller is engaged to rotate, pulling cutting line from the reserve spool or container and forcing it through a hollow tube, which is rigid or flexible, to the opposite end of a hollow rotating shaft that the cutter head is connected to. The rotating shaft is hollow on the inside so that the flexible cutting line can pass through the center of the rotating shaft to the cutter head. The rotating shaft can be the center shaft of a motor which can be powered electrically or hydraulically or an independent shaft that can be driven by belts electrically or hydraulically or an independent shaft that can be driven by belts or gears being powered by an electric motor, hydraulic motor or a fossil fuel engine This continuous feed string trimmer will have many different mounting applications. It can be mounted as a stand alone unit, with its own power source. It can be mounted as an auxiliary attachment for garden tractors, lawn mowers, tractors, all terrain vehicles, etc. with its own power source or drawing its power source from the vehicle it is attached to.

An object of this invention is to provide a continuous line feed device.

An object of this invention is to provide a continuous line feed device for lawn trimmers.

Another object of this invention is to provide a continuous line feed trimmer in which the reserve spool or container of flexible cutting line is independent from the trimmer.

Another object of this invention is to greatly increase the amount of flexible cutting line that can be held in reserve to replenish the cutting line for trimmers.

Another object of this invention is to greatly reduce the amount of down time it takes to replenish the reserve cutting line on trimmers.

### BRIEF DESCRIPTION OF THE DRAWINGS

FIG. 1. is a side view of the continuous line feed trimmer.

### ELEMENT LIST

1. Spool or Container of Cutting Line
2. Cutting Line
3. Driven Gear or Roller
4. Idler Gear or Roller
5. Tubing that cutting line passes through
6. Hollow Shaft
7. Motor (hydraulic, electric, or fossil fuel engine)
8. Cutter Head

### DETAILED DESCRIPTION OF THE INVENTION

This is a description of a drawing of a continuous feed string trimmer. The drawing is a rough sketch to show the mechanical construction and functions of the machine. The drawing is not to scale. The purpose of the machine is to greatly reduce the time it takes to rewind cutter heads of a string trimmer while it is in use. The drawing does not show any mounted applications of the continuous feed string trimmer. The drawing does not show any mounted applications because the mounting applications will be numerous from stand alone units to auxiliary attachments etc.

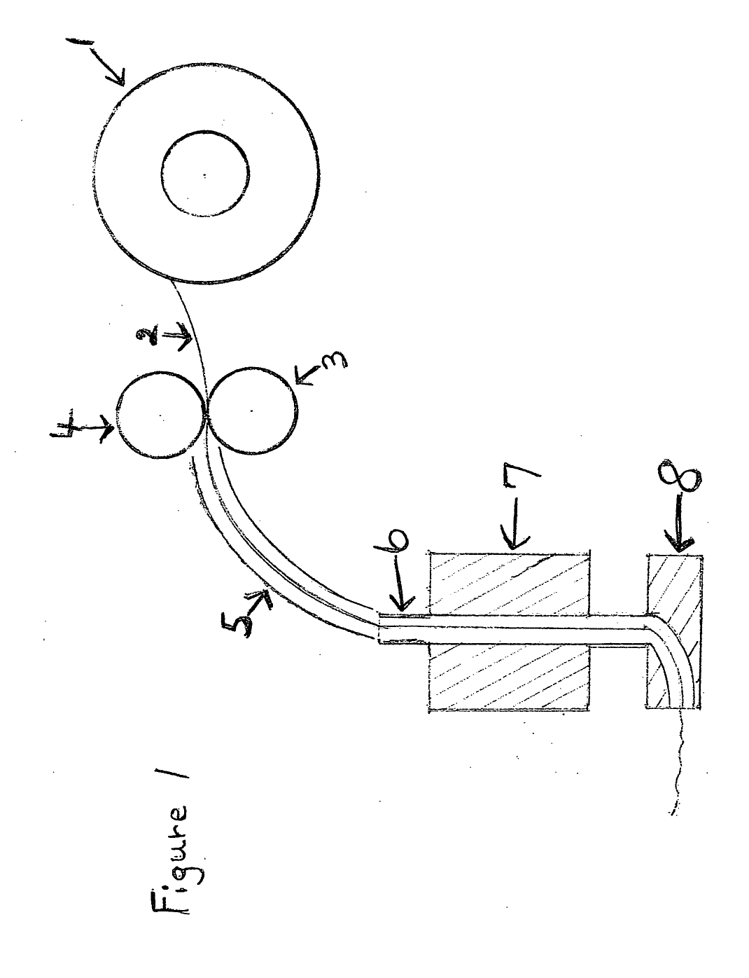

In FIG. 1 number one (1) is a spool or container of cutting line. The spool or container is independent of the trimmer and the amount of cutting line is only limited to the space allowed for the size of the spool or container.

In FIG. 1 number (2) is the cutting line, one or more lines can be used.

In FIG. 1 number three (3) is the driven gear or roller, this gear or roller pulls the cutting line, number two (2) from the spool or container number one (1) and forces it to the cutter head number eight (8). This driven gear or roller number three (3) is engaged to rotate when there is a need to extend cutting line number two (2). The driven gear or roller number three (3) can operate clockwise or counter clockwise. The driven gear or roller number three (3) can be powered hydraulically, electrically or mechanically and can be activated remotely.

In FIG. 1 number four (4) is the idler gear, this gear pushes the cutter line, number two (2) in contact with the driven gear or roller, number three (3). This gear would be mounted so that it could float and have tension adjustments towards the driven gear or roller, number three (3). The position of the driven gear or roller, number (3) and the idler gear, number four (4) can be reversed.

In FIG. 1 number five (5) is the hollow tubing that goes from the driven gear or roller, number three (3) and the idler gear or roller, number four (4) to the hollow shaft, number six (6). The hollow tubing number five (5) is not attached to the hollow shaft number six (6). The cutting line, number two (2) travels through the hollow tubing, number five (5).

In FIG. 1 number six (6) is the hollow shaft. The cutting line, number two (2) passes through the hollow shaft, number (6) from tubing, number five (5) to the cutter head number eight (8). The hollow shaft, number six (6) can be the center of a motor (hydraulic, electric or fossil fuel engine) or it can be mounted separate to be driven by belts or gears.

In FIG. 1 number seven (7) is a motor that powers the cutter head, number eight (8). The motor can be hydraulic, electric, fossil fuel engine or other or it can be mounted separate to be driven by belts or gears.

In FIG. 1 number eight (8) is the cutter head that the cutting line number two (2) passes through to come into contact with vegetation to be cut.

What is claimed is:

1. A continuous feed line trimmer comprising:
a spool or container holding the reserve flexible cutting line is independent from the trimmer.
a set of gears or rollers, one driven and one idler that are forced into contact with each other, the flexible cutting line passes between the gears or rollers at the point in which the gears or rollers make contact. When the driven gear or roller is engaged to rotate it pulls the flexible cutting line from the reserve spool or container forcing it toward the cutter head
a hollow tube that transfers the flexible cutting line from the set of gears or rollers to the opposite end of the hollow rotating shaft to which the trimmer head is attached. The shaft being powered to rotate to spin the cutter head.
a cutter head, that connects to a hollow rotating shaft, having a curved open passage way, with one opening that aligns with the opening in the hollow shaft and the other end of the curved opening exiting on the side of the cutter head.

2. A continuous feed line trimmer set forth in claim one wherein the driven gear or roller is electrically powered.

3. A continuous feed line trimmer set forth in claim one wherein the driven gear or roller is hydraulically powered.

4. A continuous feed line trimmer set forth in claim one wherein the driven gear or roller is mechanically powered.

5. A continuous feed line trimmer set forth in claim one wherein the driven gear or roller is activated remotely.

6. A continuous feed line trimmer set forth in claim one where the hollow tube is rigid.

7. A continuous feed line trimmer set forth in claim one where the hollow tube is flexible.

8. A continuous feed line trimmer set forth in claim one wherein the hollow shaft passes through the center of a motor that is hydraulically powered.

9. A continuous feed line trimmer set forth in claim one wherein the hollow shaft passes through the center of a motor that is electrically powered.

10. A continuous feed line trimmer set forth in claim one wherein the hollow shaft is independently mounted and driven by belts.

11. A continuous feed line trimmer set forth in claim one wherein the hollow shaft is independently mounted and gear driven.

12. A continuous feed line trimmer set forth in claim one wherein the hollow shaft is independently mounted and powered by a fossil fuel engine.

13. A continuous feed line trimmer set forth in claim one wherein the hollow shaft is independently mounted and powered by an electric motor.

14. A continuous feed line trimmer set forth in claim one wherein the hollow shaft is independently mounted and powered by a hydraulic motor.

15. A continuous feed line trimmer set forth in claim one where it is a stand alone unit and has its own power source.

16. A continuous feed line trimmer set forth in claim one where it can be mounted as an auxiliary attachment for garden tractors, lawn mowers, tractors, all terrain vehicles, and etc. with its own power source or drawing its power source from the vehicle it is attached to.
